(19) United States
(12) Patent Application Publication
(10) Pub. No.: US 2026/0067963 A1
(43) Pub. Date: Mar. 5, 2026

(54) TECHNIQUES TO DYNAMICALLY ENABLE AND DISABLE ACCESS TO PREMIUM WIRELESS LINKS OF A WIRELESS LOCAL AREA NETWORK FOR MULTI-LINK DEVICES

(71) Applicant: Cisco Technology, Inc., San Jose, CA (US)

(72) Inventors: Binita Gupta, San Diego, CA (US); Brian D. Hart, Sunnyvale, CA (US); Venkataprasad Chirreddy, Milpitas, CA (US); Malcolm M. Smith, Richardson, TX (US)

(21) Appl. No.: 18/978,764

(22) Filed: Dec. 12, 2024

Related U.S. Application Data
(60) Provisional application No. 63/689,086, filed on Aug. 30, 2024.

(51) Int. Cl. H04W 76/15; H04W 84/12

(52) U.S. Cl. CPC H04W 76/15; H04W 84/12

(57) ABSTRACT

Provided herein are techniques to dynamically and seamlessly enable and disable access to at least one premium wireless link based on one or more premium link criteria, thereby dynamically facilitating the seamless addition and/or deletion of one or more premium wireless links for non-access point or station (STA) Multi-Link Devices (MLDs) capable of Multi-Link Operation (MLO). Different operations for enabling access to at least one premium wireless link can be performed by an access point (AP) MLD towards a STA MLD depending on whether the STA MLD did or did not associate on at least one premium wireless link during an initial wireless association with the AP MLD.

### PRIORITY CLAIM

This application claims the benefit of priority under 35 U.S.C. § 119 to U.S. Provisional Application No. 63/689,086, filed on Aug. 30, 2024, the entirety of which application is incorporated herein by reference.

### TECHNICAL FIELD

The present disclosure relates to wireless networking.

### BACKGROUND

Networking architectures have grown increasingly complex in communications environments, particularly wireless networking environments. For wireless local area networks, Institute of Electrical and Electronics Engineers (IEEE) 802.11be (Wi-Fi® 7) defines various features to facilitate Multi-Link Operation (MLO) for Multi-Link Devices (MLDs) that are capable of associating and simultaneously exchanging data traffic on multiple Radio Frequency (RF) bands or ‘links’. With MLO, it is possible to increase the throughput for a client device by aggregating traffic across multiple links. The introduction of MLO presents new challenges and opportunities with regard to management of device access within wireless local area networks (WLANs).

### BRIEF DESCRIPTION OF THE DRAWINGS

FIG. 1 is a block diagram of a system that may be implemented to dynamically enable and disable access to one or more premium wireless links of a wireless local area network (WLAN) for Multi-Link Devices (MLDs), according to an example embodiment.

FIGS. 2A and 2B are a flowchart depicting a method according to an example embodiment.

FIG. 3 is a flowchart depicting a method according to an example embodiment.

FIG. 4 illustrates a hardware block diagram of a computing device configured to perform functions associated with operations discussed in connection with embodiments herein.

### DETAILED DESCRIPTION

### Overview

Innovations in Institute of Electrical and Electronics Engineers (IEEE) 802.11 (Wi-Fi®) standards, such as 802.11be (Wi-Fi 7) have led to the development of Multi-Link Devices (MLDs) that are capable of Multi-Link Operation (MLO). For MLO, MLDs can associate and simultaneously exchange data traffic on multiple Radio Frequency (RF) bands, such as 2.4 Gigahertz (GHz), 5 GHz, and/or 6 GHz bands. MLDs can include access point (AP) MLDs and non-AP MLDs, often referred to as MLD client devices, MLD-STAS (STA is a common abbreviation for a station), or STA MLDs.

An AP MLD can be configured with multiple STAs (multiple RF transceivers and baseband processors/Media Access Control (MAC) processors) to facilitate MLO. Similarly, a non-AP MLD can be configured with multiple STAs to facilitate MLO. As referred to herein, the terms ‘link’, ‘wireless link’, and variations thereof can be used interchangeably and can refer to a wireless connection through which a STA (of a non-AP MLD can wirelessly connect to/access a wireless connection facilitated by an AP MLD. A link may include a channel or multiple contiguous channels of a given bandwidth (e.g., 20 Megahertz (MHz), 40 MHz, 80 MHz, 160 MHz, or 320 MHz (potentially greater for future IEEE 802.11 standards).

Embodiments herein provide multi-link procedures for dynamically enabling and disabling access to at least one premium wireless link for a non-AP MLD (STA MLD) based on one or more criteria, such as determining that a Stream Classification Service (SCS) stream is setup for the STA MLD, detecting business critical or premium traffic for the STA MLD (e.g., determined based on Deep Packet Inspection (DPI) and/or Network Based Application Recognition (NBAR)/next-generation NBAR (NBAR2)), an enterprise service level agreement (SLA) policy being matched for the STA MLD/traffic flows; and/or any other network defined policy (e.g., obtained from a policy server, etc.) being matched for enabling the STA MLD to access at least one premium wireless link. In some instances, such as if a given STA MLD is capable of adding and/or deleting links without reassociation, embodiments herein may facilitate achieving the seamless addition and deletion of at least one premium wireless link without involving reassociation for the STA MLD.

In at least one embodiment, a computer-implemented method is provided that may include, for an initial wireless association between a station multi-link device (STA MLD) and an access point multi-link device (AP MLD), determining whether the STA MLD did or did not associate on a premium wireless link for the initial wireless association; following the initial wireless association, determining, based on one or more criteria, whether the STA MLD is to access the premium wireless link provided by the AP MLD; upon determining that the STA MLD is to access the premium wireless link, based on at least one of the one or more criteria being met, and that the STA MLD did not associate on the premium wireless link for the initial wireless association, determining whether the STA MLD is capable of adding or deleting wireless links without performing a wireless reassociation with the AP MLD; upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD, transmitting a Basic Service Set (BSS) Transmission Management (BTM) request frame or a Link Reconfiguration Notify frame to the STA MLD to recommend to the STA MLD to add the premium wireless link to its multi-link (ML) setup without performing a reassociation with the AP MLD; and upon determining, based on at least one of the one or more criteria being met, that the STA MLD is to access the premium wireless link and that the STA MLD did associate on the premium wireless link for the initial wireless association, transmitting a traffic identifier-to-link mapping (TTLM) to the STA MLD to enable the STA MLD to access the premium wireless link.

### Example Embodiments

In a wireless local area network (WLAN) or Wi-Fi® network, one or more wireless APs provide wireless Radio Frequency (RF) coverage over which one or more wireless devices (e.g., phones, wearable devices, tablets, etc.) can connect to the APs in order to connect to one or more data networks (e.g., the public Internet, an enterprise network operated by an enterprise entity (e.g., a business, institution, university, etc.)), and/or the like.

Current WLAN/Wi-Fi standards, such as Institute of Electrical and Electronics Engineers (IEEE) 802.11be (Wi-Fi 7), define various multi-link features for MLO, such as operations for adding and deleting links for a multi-link setup of a non-AP MLD (client/STA) without reassociation. IEEE 802.11be also defines features for Traffic Identifier (TID)-to-Link Mapping (TTLM) Mode 1 that supports features for mapping TIDs to a subset of links, Stream Classification Service (SCS) features that involve Quality of Service (QoS) characteristics to provide traffic characteristics to an AP for uplink (UL) and downlink (DL) flows for scheduling, and link recommendation features that can be used to recommend one or more links for UL and DL traffic exchanges to one or more non-AP MLDs (clients/STAs).

In enterprise deployments, there are applications (apps) that can utilize high QoS traffic, such as enterprise collaboration apps (e.g., Webex® online conference service as provided by Cisco Systems, Inc.), Virtual Reality (VR)/Augmented Reality (AR) (collectively referred to as ‘XR’ applications), and/or the like. There are also ‘premium’ devices/STAs, such as employee devices, devices with high service level agreements (SLAs), and/or the like that may utilize prioritized access to the network, over other devices (e.g. guest devices, non-premium devices, etc.).

As referred to herein, a ‘premium’ link may refer to a wireless link that can be dedicated for carrying traffic for high QoS applications and/or premium devices.

Through embodiments herein, access to a premium link may be allowed for devices that may meet one or more criteria for unlocking access to the premium link. The criteria for allowing access to the premium link can be dynamic in nature, for example, setting up of SCS stream(s) and or the like. When the criteria for accessing the premium link is no longer met, access to the premium link can be disabled, and, potentially, reenabled when the criteria are met again. Accordingly, embodiments herein may provide for the ability to dynamically enable and disable access to at least one premium link for non-AP MLDs (clients/STAs) without reassociation or service disruptions.

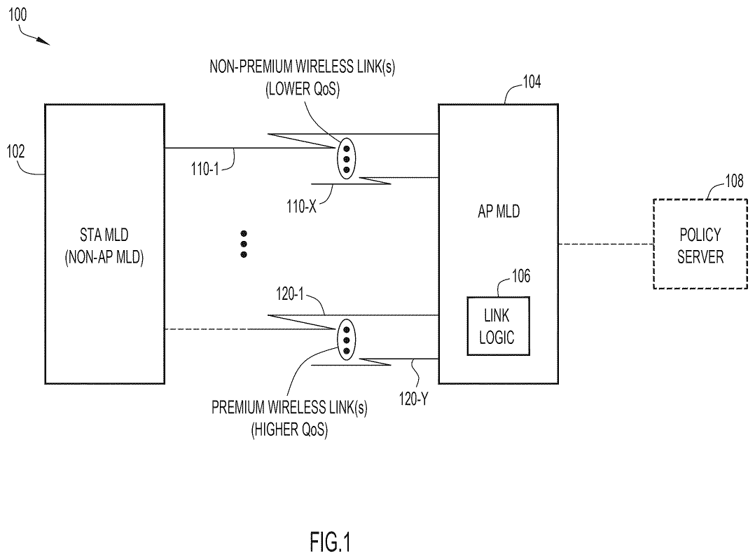

Referring to FIG. 1, FIG. 1 is a block diagram of a system 100 that may be provided to facilitate wireless connectivity for one or more premium wireless links in a WLAN, according to an example embodiment. In at least one embodiment, system 100 may include a WLAN (e.g., a Wi-Fi® network) that includes one or more station MLDs (STA MLDs) 102, also referred to herein as non-AP (non-access point) MLDs or clients that are capable of MLO. Also shown in system 100 is a wireless AP that is capable of MLO, shown in FIG. 1 as AP MLD 104. AP MLD 104 can be configured with link logic 106 in order to facilitate embodiments herein for dynamically enabling and disabling access to one or more premium links by STA MLDs, such as STA MLD 102.

AP MLD 104 can provide one or more non-premium wireless links and one or more premium wireless links. Generally, a non-premium wireless link may be characterized as a wireless link having been/being configured to provide a lower QoS for wireless connections involving clients/STAs in comparison to a premium wireless link, which has been/is configured to provide a higher QoS, such as a higher throughput, a higher bandwidth, or the like, for wireless connections involving clients/STA MLDs, such as STA MLD 102.

In some embodiments, system 100 may include a policy server 108 in which the AP MLD 104 can interface with the policy server 108 to obtain one or more enterprise policies, network policies, or the like that may be associated with the management/access for premium/non-premium wireless links provided by the AP MLD 104.

For MLO, MLDs can associate and simultaneously exchange data/traffic on multiple channels across multiple Radio Frequency (RF) bands, such as 2.4 Gigahertz (GHz), 5 GHz, and/or 6 GHz bands. Thus, as shown in FIG. 1, the AP MLD 104 and the STA MLD 102 can communicate across multiple non-premium wireless links (links) 110-1 to 110-X simultaneously and, upon AP MLD 104 (via link logic 106) determining that one or more criteria for STA MLD 102 are met, can also simultaneously communicate across one or more premium wireless links (links) 120-1 to 120-Y, potentially in combination with also simultaneously communicating across one or more of the non-premium wireless links 110-1-110-X.

As shown in FIG. 1, multiple premium wireless links may be provided by the AP MLD 104 in some embodiments. For example, in some embodiments a first premium wireless link can be provided by the AP MLD 104 that may have a first (higher) QoS level as compared to the lower QoS level non-premium wireless links 110-1-110-X and a second premium wireless link, perhaps referred to as an ‘ultra-premium’ wireless link can be provided by the AP MLD 104 that may have a second QoS level that is a higher QoS level than is provided to the first premium wireless link. Additional premium wireless links or premium wireless link hierarchies can be envisioned such that an AP MLD 104 can provide differentiated premium QoS levels for different types of traffic, applications, users, subscriptions, combinations thereof, and/or the like in accordance with embodiments herein. Each of the multiple premium wireless links may have different criteria that can be used to determine whether a user/STA MLD can access one or multiple of the premium wireless links. Thus, in some instances, a user/STA MLD can be allowed to access more than one premium wireless link simultaneously.

During operation of system 100, a non-AP MLD, such as STA MLD 102, can perform an 802.11 wireless association on multiple links with the AP MLD 104. Generally, wireless association or reassociation (referred to herein using the label ‘(re)association’) between a STA MLD and an AP MLD involves an exchange of 802.11 frames in which the goal is for the STA MLD to obtain an association ID (AID) with an AP MLD. The (re)association phase includes a strict wireless phase (e.g., an 802.11 probe request/probe response exchange or beacon reception, followed by an 802.11 authentication request/response exchange, and then an 802.11 association request/response exchange) followed by an 802.1x authentication phase (e.g., via Extensible Authentication Protocol (EAP)). Once a wireless (re)association process completes, any messages/data/traffic sent between the STA MLD and the AP MLD are part of the WLAN access.

In at least one embodiment, to load balance STA MLDs across links, the AP MLD 104 may not include a premium link in the set of links it grants for initial wireless association for some of the STA MLDs. In at least one embodiment, a STA MLD may also not request one or more premium links in its set of associated links. In at least one embodiment, a STA MLD may be allowed to wirelessly associate on a premium link upon the AP MLD 104 (via link logic 106) determining, based on a device type policy, a user policy, etc. that the STA MLD and/or a user associated therewith is allowed to associate on at least one premium link of the premium links 120-1-120-M.

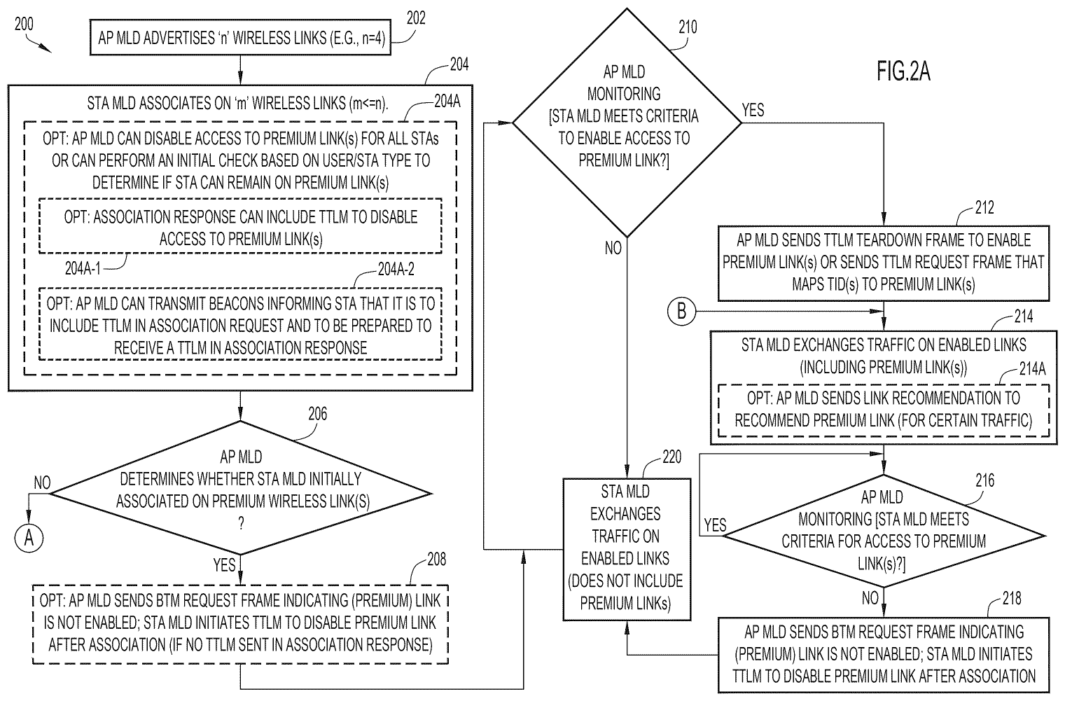

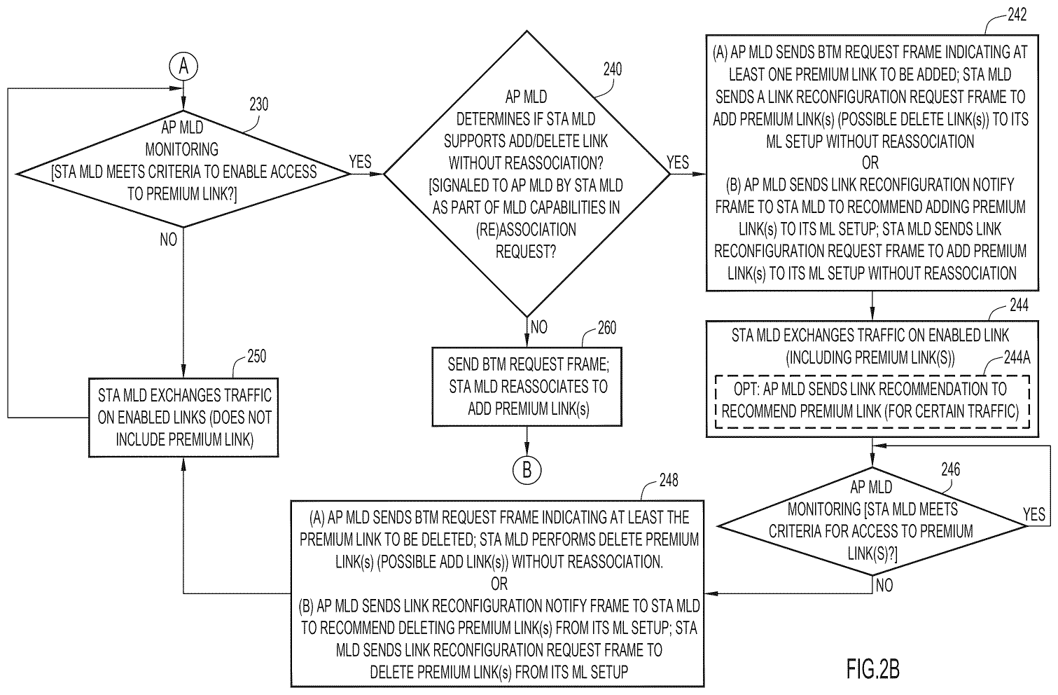

As a result, a STA MLD, such as STA MLD 102, may or may not be wirelessly associated on a premium link upon initial association with the AP MLD. In at least one embodiment, it may be desirable to only enable access to one or more premium links for a STA MLD when one or more criteria for accessing at least one premium link (or, in some instances, multiple premium wireless links) are met by the STA MLD, traffic thereof, etc., as discussed in further detail below, with reference to FIGS. 2A and 2B.

Referring to FIGS. 2A and 2B, FIGS. 2A and 2B are a flowchart depicting a method 200, according to an example embodiment. In at least one embodiment, method 200 illustrates operations that may be performed at least in part by the AP MLD 104, via link logic as shown in FIG. 1. Broadly, FIGS. 2A and 2B illustrates an example flow involving procedures that may be utilized to facilitate premium link operations, for example, to dynamically enable and disable access to at least one premium link for a non-AP MLD, such as STA MLD 102, by AP MLD 104.

As illustrated at least with reference to FIGS. 2A and 2B, embodiments herein provide procedures to dynamically and seamlessly enable and disable access to at least one premium wireless link (e.g., any of premium wireless links 120-1-120-Y), covering two scenarios when, at the start, following initial wireless association, it is determined that the STA MLD 102 did initially associate/has initially associated on at least one premium wireless link or it is determined that the STA MLD 102 did not initially associate/has not initially associated on at least one premium wireless link.

For example, with reference to FIG. 2A, consider at 202 that the AP MLD 104 advertises (e.g., via beacon frames), an ‘n’ number of wireless links (links), for example, n=4. As shown at 204, the STA MLD 102 can perform initial wireless association on an ‘m’ number of links, where m<=4. In various embodiments, AP MLD 104 (via link logic 106) can store an indication of whether the STA MLD 102 did or did not initially associate on one or more premium wireless links provided by the AP MLD 104.

During the initial wireless association between STA MLD 102 and AP MLD 104, the STA MLD 102 can signal its MLD capabilities towards the AP MLD 104 (per 802.11 standards), via a (re)association Request frame and/or via a Link Reconfiguration Request frame. In particular (as discussed further below with reference to FIG. 2B), the STA MLD 102 can signal MLD capabilities toward the AP MLD 104 indicating whether it is capable of adding and/or deleting links without performing a reassociation. Such an add/delete link without reassociation capability is provided under IEEE 802.11be that may be supported by various STA MLDs. For example, such an add/delete without reassociation capability can be indicated by the Link Reconfiguration Operation Support capability that can identified be in the Basic ML (multi-link) element signaled by the STA MLD 102 to the AP MLD 104 during the initial wireless association.

In various embodiments for the initial wireless association, as shown at 204A, the AP MLD 104 can disable access to premium links for all STA MLDs that associate to the AP MLD 104, or the AP MLD 104 may perform an initial check based on user/STA MLD device type (e.g., determining if the user/STA MLD is classified as a ‘premium’ user/STA MLD) to determine whether a given STA MLD can remain on one or more premium wireless links. Operations 202 and 204, as well as operations 206 and 208 discussed below, can be performed before data traffic is flowing/exchanged between the STA MLD 102 and the AP MLD 104; thus, any initial checks performed for determining whether the STA MLD 102 can remain on one or more premium link(s) may be limited to device type/user checks, which, in some embodiments, may be performed via enterprise/network policy checks initiated towards policy server 108.

### STA MLD Associates on a Premium Link (FIG. 2A)

In at least one embodiment, as shown at 204A-1, if the STA MLD 102 associates on at least one premium link and if the user/STA MLD 102 has not met the criteria for enabling access to the at least one premium link (e.g. user/STA MLD 102 is not a considered premium user/STA MLD), then the AP MLD 104 can include a TID-To-Link Mapping (TTLM) element (as prescribed at least by IEEE 802.11be/D7.0, August 2024, Section 35.3.7.2) in an Association Response frame sent to the STA MLD 102 that maps all TIDs (traffic identifiers) to a link set that does not include any premium link(s), in order to disable premium link access for the STA MLD 102.

In at least one embodiment, the TTLM sent by the AP MLD 104 in the Association Response mapping all TIDs to a link set that does not include any premium link(s) can be an unsolicited TTLM sent by the AP MLD 104. In some embodiments, the STA MLD 102 can request a TTLM in an Association Request, such that the TTLM sent by the AP MLD 104 (mapping all TIDs to a link set not including any premium link(s)) may be a solicited TTLM. In still some embodiments, the STA MLD 102 can include a TTLM in an Association Request sent to the AP MLD 104, which can trigger the AP MLD 104 to include the TTLM (mapping all TIDs to a link set not including any premium link(s)) in the Association Response.

In yet some embodiments, as shown at 204A-2, the AP MLD 104 can transmit or advertise via beacon(s) that inform the STA MLD 102 that it is to include a TTLM in its Association Request and to be prepared to receive a TTLM (e.g., mapping all TIDs to a link set not including any premium link(s)) in an Association Response. For example, the AP MLD 104 can obtain a TTLM from the STA MLD 102 for the initial wireless association and, upon determining that the STA MLD 102 is not allowed access on the premium wireless link at the initial wireless association, the AP MLD 104 can send another TTLM to the STA MLD 102 in an association response to disable access to the premium wireless link(s).

In an embodiment alternate to 204A-1, the AP MLD 104 may not send a TTLM element in an Association Response frame disabling premium link access. Instead, as shown at 208, after the wireless association between the STA MLD 102 and the AP MLD 104, the AP MLD 104 can send a BTM (Basic Service Set (BSS) Transition Management) Request frame to the STA MLD 102 recommending to the STA MLD 102 a link set that does not include the premium link(s) or, stated differently, that does not indicate the premium wireless link(s) as enabled. The BTM Request frame can trigger the STA MLD 102 to send a TTLM request that maps all TIDs to a link set that does not include the premium link(s), disabling access to the premium link(s). The format of a BTM Request frame that can be used in conjunction with embodiments herein is prescribed at least by IEEE 802.11-REVme/D7.0, August 2024, Section 9.6.13.9, and the format of a Link Recommendation frame (an Action frame) that can be used in conjunction with embodiments herein is prescribed at least by IEEE 802.11be/D7.0, August 2024, Section 9.6.38.9.

Following any combination of operations for 204, the AP MLD 104 (via link logic 106), as shown at 206, can determine whether the STA MLD 102 did or did not initially associate on any premium wireless link(s). Upon determining that the STA MLD 102 did not initially associate on any premium wireless link(s) (NO at 206), the operations can continue to 230 of FIG. 2B, shown as label (A) in FIGS. 2A and 2B in which 230 is discussed in further detail, below.

However, if the AP MLD 104 determines at 206 that the STA MLD 102 did associate on or more premium wireless link(s) (YES at 206), the operations can continue to 210 (and, optionally, 208 as discussed above, depending on whether any of the operations discussed for 204 were or were not performed during the initial wireless association). As shown at 210, the AP MLD 104, via link logic 106, can monitor the STA MLD 102 (e.g., monitor data traffic, monitor stream(s) setup, monitor policies/SLAs that may be enabled/activated for the STA MLD 102, etc.) in relation to one or more criteria (also referred to herein as ‘premium link criteria’) in order to determine whether one or more criteria may be met for enabling access to premium link(s) for the STA MLD 102.

In various embodiments, criteria for enabling access to one or more premium link(s) for a STA MLD (e.g., STA MLD 102) may include one or more of following:
Detecting one or more SCS streams being setup for a STA MLD;
Detecting business critical or other premium traffic for a STA MLD (e.g., determined based on Deep Packet Inspection (DPI) and/or Network Based Application Recognition (NBAR)/next-generation NBAR (NBAR2);
Determining an enterprise SLA policy being matched for a user/STA MLD/traffic flows; and/or
Determining any other network defined policy (e.g., obtained from the policy server 108, etc.) being matched for a user/STA MLD for accessing premium link(s).

Upon determining that one of more of the premium link criteria for the STA MLD 102 are not met (NO at 210), the operations can continue to 220 at which the STA MLD 102 exchanges traffic on its enabled (non-premium) link(s) and the AP MLD 104 continues monitoring for the STA MLD 102 with regard to the various premium link criteria.

However, upon determining that one or more of the criteria are met for accessing the premium link (YES at 210), the AP MLD 104 can, in at least one embodiment as shown at 212, send a TTLM Teardown frame to tear down the existing TTLM, now allowing TIDs to be mapped to at least one premium link, thus enabling access/connectivity to at least one premium link. In another embodiment, the AP MLD 104 can send a revised TTLM Request frame that includes mapping all TIDs to the premium link, thus enabling connectivity/access to the premium link.

As shown at 214, after access to the premium link(s) is/are enabled for the STA MLD 102, the STA MLD 102 can exchange traffic on the enabled links, including the premium link(s). In at least one embodiment as shown at 214A, after the premium link access is enabled, the AP MLD 104 may optionally also send a Link Recommendation frame to the STA MLD 102 to recommend the premium link(s) that is/are to be used for UL and DL traffic exchanges by the STA MLD 102. For example, the STA MLD 102 may not know which traffic is to be communicated using the premium link such that sending the Link Recommendation frame to the STA MLD 102 can be used to recommend that the premium link be used for communicating certain (UL/DL) traffic by the STA MLD 102.

Although example details for the operations of FIGS. 2A and 2B are discussed with reference to at least one premium wireless link, it is to be understood that the AP MLD 104 can determine, based on one or more criteria, to allow the STA MLD 102 to access more than one premium wireless link.

As shown at 216, the AP MLD 104 can continue monitoring for the STA MLD 102 with regard to the various premium link criteria that allow for enabling premium link access. As long as the STA MLD 102 continues to meet the various premium criteria (YES at 216), the monitoring continues. However, if and/or when the criteria for accessing the premium link(s) is/are no longer met for the STA MLD 102 (NO at 216), then the AP MLD 104 can, as shown at 218, send a BTM Request frame to the STA MLD 102 recommending to the STA MLD 102 a link set that does not include the premium link(s)/that does not indicate the premium link(s) as enabled, as discussed above at 208. This can trigger the STA MLD 102 to send a TTLM Request that maps all TIDs to a link set that does not include the premium link(s), thus disabling access to the premium link(s).

Thereafter, the operations can continue to 220 and 210, as discussed above, at which the STA MLD 102 exchanges traffic on its enabled (non-premium) link(s) and the AP MLD 104 continues monitoring for the STA MLD 102 with regard to the various premium link criteria.

STA MLD does not Associate on a Premium Link

With reference to the decision at 206 of FIG. 2A at which the AP MLD 104 determines whether the STA MLD 102 did or did not initially associate on any premium wireless link(s), upon determining that the STA MLD 102 did not initially associate on any premium wireless link(s) (NO at 206), the operations can continue to 230 of FIG. 2B, now discussed in further detail.

In at least one embodiment as shown at 230, if the STA MLD 102 does not associate on any premium link(s) during the initial association, then the AP MLD 104 can perform monitoring for the STA MLD 102 to check if any of the premium link criteria is/are met for enabling access to at least one premium link for the STA MLD 102.

Upon determining that one of more of the premium link criteria for the STA MLD 102 are not met (NO at 230), the operations can continue to 250 at which the STA MLD 102 exchanges traffic on its enabled (non-premium) link(s) and the AP MLD 104 continues monitoring for the STA MLD 102 with regard to the various premium link criteria.

However, upon determining that one or more premium link criteria are met for accessing at least one premium link (YES at 230), the AP MLD 104 further checks, as shown at 240, to determine if the STA MLD 102 supports the capability of adding and deleting links to its ML setup without reassociation, as can indicated by the Link Reconfiguration Operation Support capability in the Basic ML element sent by the STA MLD 102 to the AP MLD 104 during association (as discussed above with reference to operations at 204).

In at least one embodiment, if the AP MLD 104 determines that the STA MLD 102 does support adding and deleting links without reassociation (YES at 240), then the AP MLD 104 can send a BTM Request frame to the STA MLD 102 recommending to the STA MLD 102 to add the premium link(s) and, optionally (if needed), to delete one or more existing link(s) without the STA MLD 102 performing a reassociation, as shown at 242, part (A) in which the STA MLD 102 sends a Link Reconfiguration Request frame to the AP MLD 104 to request adding the premium link(s) to the ML setup of the STA MLD 102. The AP MLD 104 sends a Link Reconfiguration Response frame to the STA MLD 102 to accept addition of the premium link(s) to the ML setup for the STA MLD 102, thus enabling connectivity/access to the premium link(s) for the STA MLD 102.

In at least one embodiment, the AP MLD 104 can send a Link Reconfiguration Notify frame to the STA MLD 102 to recommend to the STA MLD 102 to add the premium link(s) to its ML setup without the STA MLD 102 performing a reassociation and, optionally (if needed), to delete an existing link, as shown at 242, part (B), in which the STA MLD 102 can send a Link Reconfiguration Request frame to the AP MLD 104 to request adding the premium link(s) to the ML setup of the STA MLD 102. The AP MLD 104 can send a Link Reconfiguration Response frame to the STA MLD 102 to accept addition of the premium link(s) to the ML setup for the STA MLD 102, thus enabling connectivity/access to the premium link(s) for the STA MLD 102. Link Reconfiguration Notify, Request, and Response frames that can be utilized in conjunction with embodiments herein are prescribed at least by IEEE 802.11be/D7.0, August 2024, Sections 9.6.38.12 and 9.6.38.13.

While a set of links that may be deleted by the STA MLD 102 are implied through use of the BTM option of 242, part (A), the Link Reconfiguration Notify option of 242, part (B) may be used to explicitly indicate the link(s) that the STA MLD 102 is to delete. Thus, the AP MLD 104 can send a Link Reconfiguration Notify frame to the STA MLD 102 to provide a more explicit indication for adding the premium link and deleting the one or more other links.

As shown at 244, after access to the premium link(s) is/are enabled for the STA MLD 102, the STA MLD 102 can exchange traffic on the enabled links, including the premium link(s). In at least one embodiment as shown at 244A, after the premium link access is enabled, the AP MLD 104 may optionally also send a Link Recommendation frame to the STA MLD 102 to recommend the premium link(s) that is/are to be used for UL and DL traffic exchanges by the STA MLD 102

As shown at 246, the AP MLD 104 can continue monitoring for the STA MLD 102 with regard to the various premium link criteria that allow for enabling premium link access. As long as the STA MLD 102 continues to meet the various premium link criteria (YES at 246), the monitoring continues. However, if and/or when the criteria for accessing the premium link(s) is/are no longer met for the STA MLD 102 (NO at 246), then the AP MLD 104 can, as shown at 248, send a BTM Request frame to the STA MLD 102 recommending to the STA MLD 102 to delete the premium link(s), as shown at 248, part (A).

In at least one embodiment, the AP MLD 104 can send a Link Reconfiguration Notify frame to the STA MLD 102 to recommend to the STA MLD 102 to delete the premium link(s) from its ML setup, as shown at 248, part (B), in which the STA MLD 102 can send a Link Reconfiguration Request frame to request deleting the premium link(s) from its ML setup. The AP MLD 104 can send a Link Reconfiguration Response frame to the STA MLD 102 to accept deletion of the premium link(s) from the ML setup for the STA MLD 102, thus disabling connectivity/access to the premium link(s) for the STA MLD 102.

Returning to 240, in at least one embodiment, if the non-AP MLD does not support adding and deleting links without reassociation (NO at 240), then at least one technique through which to add the premium link would be through reassociation. In such an embodiment, as shown at 260, the AP MLD 104 can send a BTM Request frame recommending the premium link(s) to the STA MLD 102, which can trigger the STA MLD 102 to perform reassociation with the AP MLD 104 and associate on a link set that now includes the premium link(s). Thereafter, the operations can continue to 214 of FIG. 2A (shown as label (B) in FIG. 2B and FIG. 2A) and continue therefrom, as discussed herein for FIG. 2A.

Accordingly, embodiments herein may enable premium link operation to facilitate dynamically enabling or disabling access to at least one premium wireless link for STA MLDs by an AP MLD.

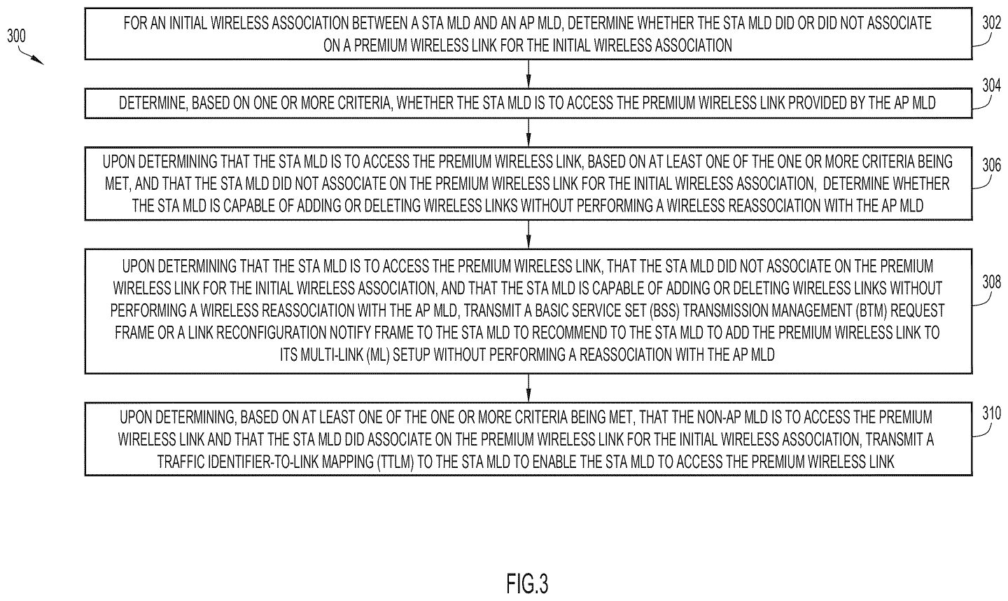

Referring to FIG. 3, FIG. 3 is a flowchart depicting a method 300 according to an example embodiment. In at least one embodiment, method 300 may be associated with operations that can be performed, at least by an AP MLD, such as AP MLD 104, to facilitate dynamically enabling or disabling access to at least one premium wireless link for a STA MLD, such as STA MLD 102.

As shown at 302, the method may include, for an initial wireless association between a STA MLD and an AP MLD, determining whether the STA MLD did or did not associate on a premium wireless link for the initial wireless association.

At 304, the method may include, following the initial wireless association, determining, based on one or more criteria (e.g., premium link criteria), whether the STA MLD is to access the premium wireless link provided by the AP MLD. In at least one embodiment determining, based on one or more criteria, whether the STA MLD is to access the premium wireless link includes one or more of: determining that a Stream Classification Service (SCS) stream that is to utilize the premium wireless link is setup for the STA MLD; determining that the STA MLD is communicating data traffic that is to utilize the premium wireless link; determining, based on a service level agreement (SLA) for the STA MLD, that the STA MLD is to access the premium wireless link; or determining, based on a policy associated with the STA MLD or a user associated with the STA MLD, that the STA MLD is to access the premium wireless link.

As shown at 306, upon determining that the STA MLD is to access the premium wireless link, based on at least one of the one or more criteria being met, and that the STA MLD did not associate on the premium wireless link for the initial wireless association, the method may further include determining whether the STA MLD is capable of adding or deleting wireless links without performing a wireless reassociation with the AP MLD. The determining at 306 can be determined based on a Link Reconfiguration Operation Support capability indicated by the STA MLD included in a Basic ML element sent by the STA MLD to the AP MLD during the initial wireless association that can indicate that the STA MLD is capable of adding/deleting link(s) without performing reassociation.

As shown at 308, upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD, the method may include transmitting a Basic Service Set (BSS) Transmission Management (BTM) request frame or a Link Reconfiguration Notify frame to the STA MLD to recommend to the STA MLD to add the premium wireless link to its multi-link (ML) setup without performing a reassociation with the AP MLD.

As shown at 310, upon determining, based on at least one of the one or more criteria being met, that the STA MLD is to access the premium wireless link and that the STA MLD did associate on the premium wireless link for the initial wireless association, the method may include transmitting a traffic identifier-to-link mapping (TTLM) to the STA MLD to enable the STA MLD to access the premium wireless link.

In at least one embodiment, although not shown in FIG. 3, the method may include, upon determining that the STA MLD is to access the premium wireless link, that the STA MLD did not associate on the premium wireless link for the initial wireless association, and that the STA MLD is not capable of adding or deleting wireless links without performing a wireless reassociation with the AP MLD, transmitting a BTM request frame to the STA MLD to cause the STA MLD to perform a reassociation with the AP MLD to associate to a link set that includes the premium wireless link.

In at least one embodiment, transmitting the link reconfiguration notify frame to the STA MLD to recommend to the STA MLD to add the premium wireless link to its ML setup is to cause the STA MLD to send a link reconfiguration request frame to the AP MLD to add the premium wireless link to its ML setup.

In at least one embodiment, the method may include sending a link recommendation frame to the STA MLD to recommend the premium link to be used for certain traffic that is to be communicated by the STA MLD.

In at least one embodiment, the method may further include following the STA MLD accessing the premium wireless link, determining that the STA MLD is to not access the premium wireless link; and transmitting another BTM request frame to the STA MLD to cause the STA MLD to cause the STA MLD to delete the premium wireless link from the multi-link setup of the STA MLD without performing a wireless reassociation with the AP MLD or to cause the STA MLD to initiate sending another TTLM to the AP MLD to disable the premium wireless link.

In at least one embodiment, upon determining that the STA MLD did associate on the premium wireless link for the initial wireless association, the method can include disabling access to the premium wireless link for the STA MLD by the AP MLD. In at least one embodiment, disabling access to the premium wireless link by the AP MLD includes transmitting a BTM request frame to the STA MLD that does not indicate the premium wireless link as enabled in order to cause the STA MLD to send a Traffic Identifier (TID)-to-Link Mapping (TTLM) that identifies, at least in part, the premium wireless link is disabled for the STA MLD.

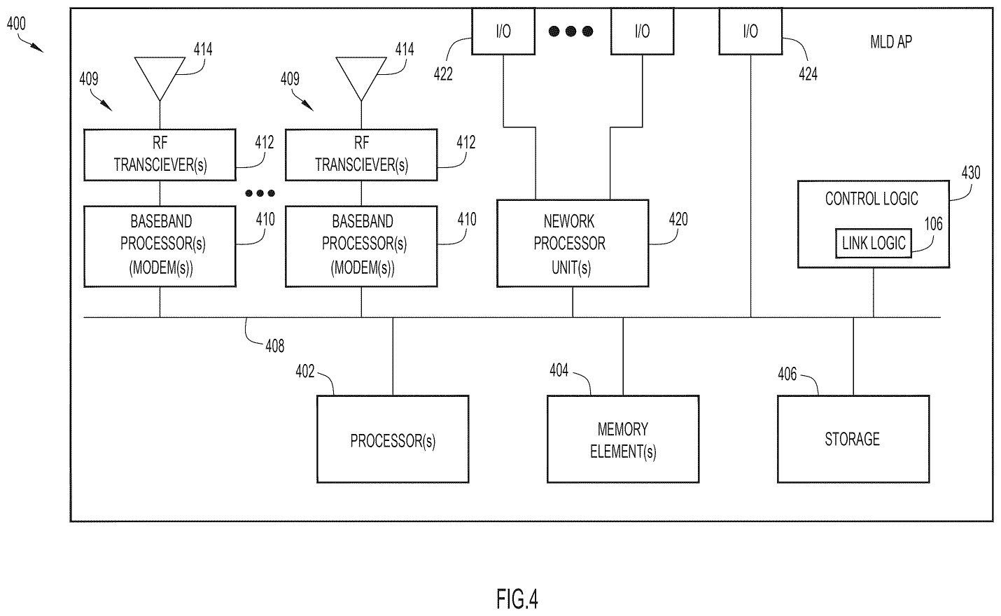

Referring to FIG. 4, FIG. 4 illustrates a hardware block diagram of an AP MLD 400 that may perform functions associated with operations discussed herein in connection with the techniques described for embodiments herein.

In at least one embodiment, the AP MLD 400 may be any apparatus that may include one or more processor(s) 402, one or more memory element(s) 404, storage 406, a bus 408, a plurality of AP modules 409 each consisting of a baseband processor (modem) 410, one or more RF transceivers 412 and an antenna 414 (or group of antennas). The AP MLD 400 may further include one or more network processor unit(s) 420 interconnected with one or more network input/output (I/O) interface(s) 422, one or more I/O interface(s) 424, and control logic 430. In various embodiments, instructions associated with logic for AP MLD 400 can overlap in any manner and are not limited to the specific allocation of instructions and/or operations described herein.

In at least one embodiment, processor(s) 402 is/are at least one hardware processor configured to execute various tasks, operations and/or functions for AP MLD 400 as described herein according to software and/or instructions configured for AP MLD 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 404 and/or storage 406 is/are configured to store data, information, software, and/or instructions associated with AP MLD 400, and/or logic configured for memory element(s) 404 and/or storage 406. For example, any logic described herein (e.g., control logic 430) can, in various embodiments, be stored for AP MLD 400 using any combination of memory element(s) 404 and/or storage 406. Note that in some embodiments, storage 406 can be consolidated with memory element(s) 404 (or vice versa) or can overlap/exist in any other suitable manner.

In at least one embodiment, bus 408 can be configured as an interface that enables one or more elements of AP MLD 400 to communicate in order to exchange information and/or data. Bus 408 can be implemented with any architecture designed for passing control, data and/or information between processors, memory elements/storage, peripheral devices, and/or any other hardware and/or software components that may be configured for AP MLD 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 420 may enable communication between AP MLD 400 and other systems, entities, etc., via network I/O interface(s) 422 (wired and/or wireless) to facilitate operations discussed for various embodiments described herein. In various embodiments, network processor unit(s) 420 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between AP MLD 400 and other systems, entities, etc. to facilitate operations for various embodiments described herein. In various embodiments, network I/O interface(s) 422 can be configured as one or more Ethernet port(s), Fibre Channel ports, any other I/O port(s), and/or antenna(s)/antenna array(s) now known or hereafter developed. Thus, the network processor unit(s) 420 and/or network I/O interface(s) 422 may include suitable interfaces for receiving, transmitting, and/or otherwise communicating data and/or information (wired and/or wirelessly) in a network environment.

I/O interface(s) 424 allow for input and output of data and/or information with other entities that may be connected to AP MLD 400. For example, I/O interface(s) 424 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 412 may perform RF transmission and RF reception of wireless signals via antenna(s) 414, and the baseband processor or modem 410 performs baseband modulation and demodulation, etc. associated with such signals to enable wireless communications for AP MLD 400.

In various embodiments, control logic 430 (which may include/be configured with link logic 106 of FIG. 1) can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 430 including link logic 106) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 404 and/or storage 406 can store data, software, code, instructions (e.g., processor instructions), logic, parameters, combinations thereof, and/or the like used for operations described herein. This includes memory element(s) 404 and/or storage 406 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that may include, for an initial wireless association between a station multi-link device (STA MLD) and an access point multi-link device (AP MLD), determining whether the STA MLD did or did not associate on a premium wireless link for the initial wireless association; following the initial wireless association, determining, based on one or more criteria, whether the STA MLD is to access the premium wireless link provided by the AP MLD; upon determining that the STA MLD is to access the premium wireless link, based on at least one of the one or more criteria being met, and that the STA MLD did not associate on the premium wireless link for the initial wireless association, determining whether the STA MLD is capable of adding or deleting wireless links without performing a wireless reassociation with the AP MLD; upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD: transmitting a Basic Service Set (BSS) Transmission Management (BTM) request frame or a link reconfiguration notify frame to the STA MLD to recommend to the STA MLD to add the premium wireless link to its multi-link (ML) setup without performing a reassociation with the AP MLD; and upon determining, based on at least one of the one or more criteria being met, that the STA MLD is to access the premium wireless link and that the STA MLD did associate on the premium wireless link for the initial wireless association, transmitting a traffic identifier-to-link mapping (TTLM) to the STA MLD to enable the STA MLD to access the premium wireless link.

In one instance, the method may include, upon determining that the STA MLD is to access the premium wireless link, that the STA MLD did not associate on the premium wireless link for the initial wireless association, and that the STA MLD is not capable of adding or deleting wireless links without performing a wireless reassociation with the AP MLD, transmitting a BTM request frame to the STA MLD to cause the STA MLD to perform a reassociation with the AP MLD to associate to a link set that includes the premium wireless link.

In one instance, transmitting the link reconfiguration notify frame to the STA MLD to recommend to the STA MLD to add the premium wireless link to its ML setup is to cause the STA MLD to send a link reconfiguration request frame to the AP MLD to add the premium wireless link to its ML setup.

In one instance, transmitting the BTM request frame to the STA MLD to recommend to the STA MLD to add the premium wireless link to its ML setup is to cause the STA MLD to send a link reconfiguration request frame to the AP MLD to add the premium wireless link to its ML setup.

In one instance, the method may include, following the STA MLD accessing the premium wireless link, determining that the STA MLD is to not access the premium wireless link, based on at least one of the one or more criteria being not being met for accessing the premium wireless link; and transmitting another BTM request frame to the STA MLD to cause the STA MLD to cause the STA MLD to delete the premium wireless link from the ML setup of the STA MLD without performing a wireless reassociation with the AP MLD or to cause the STA MLD to initiate sending another TTLM to the AP MLD to disable the premium wireless link.

In one instance, the method may include sending a link recommendation frame to the STA MLD to recommend the premium wireless link is to be used for certain traffic that is to be communicated by the AP STA MLD.

In one instance, the method may include advertising, by the AP MLD, that the STA MLD is to include a TTLM in an association request for the initial wireless association; obtaining, by the AP MLD, the TTLM from the STA MLD for the initial wireless association; and upon determining that the STA MLD is not allowed access on the premium wireless link at the initial wireless association, sending another TTLM to the to the STA MLD in an association response to disable access to the premium wireless link for the STA MLD.

In one instance, the method may include upon determining that the STA MLD is not allowed access on the premium wireless link at the initial wireless association, sending, by the AP MLD, a TTLM to the STA MLD for the initial wireless association to disable access to the premium wireless link by the STA MLD.

In one instance, the method may include upon determining that the STA MLD did associate on the premium wireless link for the initial wireless association, disabling access to the premium wireless link for the STA MLD by the AP MLD. In one instance, disabling access to the premium wireless link by the AP MLD includes transmitting a BTM request frame to the STA MLD that does not indicate the premium wireless link as enabled indicating that the premium wireless link is not enabled in order to cause the STA MLD to send a Traffic Identifier (TID)-to-Link Mapping (TTLM) that identifies, at least in part, the premium wireless link is disabled for the STA MLD.

In various instances, determining, based on one or more criteria, whether the STA MLD is to access the premium wireless link includes one or more of: determining that a Stream Classification Service (SCS) stream that is to utilize the premium wireless link is setup for the STA MLD; determining that the STA MLD is communicating data traffic that is to utilize the premium wireless link; determining, based on a service level agreement (SLA) for the STA MLD, that the STA MLD is to access the premium wireless link; or determining, based on a policy associated with the STA MLD or a user associated with the STA MLD, that the STA MLD is to access the premium wireless link.

In one instance, the AP MLD provides a plurality of non-premium wireless links and a plurality of premium wireless links. In one instance, the AP MLD allows the STA MLD, based on one or more criteria, to access to more than one premium wireless link of the plurality of premium wireless links.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
for an initial wireless association between a station multi-link device (STA MLD) and an access point multi-link device (AP MLD), determining whether the STA MLD did or did not associate on a premium wireless link for the initial wireless association;
following the initial wireless association, determining, based on one or more criteria, whether the STA MLD is to access the premium wireless link provided by the AP MLD;
upon determining that the STA MLD is to access the premium wireless link, based on at least one of the one or more criteria being met, and that the STA MLD did not associate on the premium wireless link for the initial wireless association, determining whether the STA MLD is capable of adding or deleting wireless links without performing a wireless reassociation with the AP MLD;
upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD, transmitting a Basic Service Set (BSS) Transmission Management (BTM) request frame or a link reconfiguration notify frame to the STA MLD to recommend to the STA MLD to add the premium wireless link to its multi-link (ML) setup without performing a reassociation with the AP MLD and
upon determining, based on at least one of the one or more criteria being met, that the STA MLD is to access the premium wireless link and that the STA MLD did associate on the premium wireless link for the initial wireless association, transmitting a traffic identifier-to-link mapping (TTLM) to the STA MLD to enable the STA MLD to access the premium wireless link.

2. The method of claim 1, further comprising:
upon determining that the STA MLD is to access the premium wireless link, that the STA MLD did not associate on the premium wireless link for the initial wireless association, and that the STA MLD is not capable of adding or deleting wireless links without performing a wireless reassociation with the AP MLD, transmitting a BTM request frame to the STA MLD to cause the STA MLD to perform a reassociation with the AP MLD to associate to a link set that includes the premium wireless link.

3. The method of claim 1, wherein transmitting the link reconfiguration notify frame to the STA MLD to recommend to the STA MLD to add the premium wireless link to its ML setup is to cause the STA MLD to send a link reconfiguration request frame to the AP MLD to add the premium wireless link to its ML setup.

4. The method of claim 1, wherein transmitting the BTM request frame to the STA MLD to recommend to the STA MLD to add the premium wireless link to its ML setup is to cause the STA MLD to send a link reconfiguration request frame to the AP MLD to add the premium wireless link to its ML setup.

5. The method of claim 1, further comprising:
following the STA MLD accessing the premium wireless link, determining that the STA MLD is to not access the premium wireless link, based on at least one of the one or more criteria not being met for accessing the premium wireless link; and
transmitting another BTM request frame to the STA MLD to cause the STA MLD to delete the premium wireless link from the ML setup of the STA MLD without performing a wireless reassociation with the AP MLD or to cause the STA MLD to initiate sending another TTLM to the AP MLD to disable the premium wireless link.

6. The method of claim 1, further comprising:
sending a link recommendation frame to the STA MLD to recommend the premium wireless link is to be used for certain traffic that is to be communicated by the STA MLD.

7. The method of claim 1, further comprising:
advertising, by the AP MLD, that the STA MLD is to include a TTLM in an association request for the initial wireless association;
obtaining, by the AP MLD, the TTLM from the STA MLD for the initial wireless association; and
upon determining that the STA MLD is not allowed access on the premium wireless link at the initial wireless association, sending another TTLM to the STA MLD in an association response to disable access to the premium wireless link for the STA MLD.

8. The method of claim 1, further comprising:
upon determining that the STA MLD is not allowed access on the premium wireless link at the initial wireless association, sending, by the AP MLD, a TTLM to the STA MLD for the initial wireless association to disable access to the premium wireless link by the STA MLD.

9. The method of claim 1, further comprising:
upon determining that the STA MLD did associate on the premium wireless link for the initial wireless association, disabling access to the premium wireless link for the STA MLD by the AP MLD.

10. The method of claim 9, wherein disabling access to the premium wireless link by the AP MLD includes transmitting a BTM request frame to the STA MLD that does not indicate the premium wireless link as enabled in order to cause the STA MLD to send a TTLM that identifies, at least in part, the premium wireless link is disabled for the STA MLD.

11. The method of claim 1, wherein determining, based on one or more criteria, whether the STA MLD is to access the premium wireless link includes one or more of:
determining that a Stream Classification Service (SCS) stream that is to utilize the premium wireless link is setup for the STA MLD;
determining that the STA MLD is communicating data traffic that is to utilize the premium wireless link;
determining, based on a service level agreement (SLA) for the STA MLD, that the STA MLD is to access the premium wireless link; or
determining, based on a policy associated with the STA MLD or a user associated with the STA MLD, that the STA MLD is to access the premium wireless link.

12. The method of claim 1, wherein the AP MLD provides a plurality of non-premium wireless links and a plurality of premium wireless links.

13. The method of claim 12, wherein the AP MLD allows the STA MLD, based on one or more criteria, to access to more than one premium wireless link of the plurality of premium wireless links.

14. One or more non-transitory computer readable storage media encoded with instructions that, when executed by a processor, cause the processor to perform operations, comprising:
for an initial wireless association between a station multi-link device (STA MLD) and an access point multi-link device (AP MLD), determining whether the STA MLD did or did not associate on a premium wireless link for the initial wireless association;
following the initial wireless association, determining, based on one or more criteria, whether the STA MLD is to access the premium wireless link provided by the AP MLD;
upon determining that the STA MLD is to access the premium wireless link, based on at least one of the one or more criteria being met, and that the STA MLD did not associate on the premium wireless link for the initial wireless association, determining whether the STA MLD is capable of adding or deleting wireless links without performing a wireless reassociation with the AP MLD;
upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD, transmitting a Basic Service Set (BSS) Transmission Management (BTM) request frame or a link reconfiguration notify frame to the STA MLD to recommend to the STA MLD to add the premium wireless link to its multi-link (ML) setup without performing a reassociation with the AP MLD; and
upon determining, based on at least one of the one or more criteria being met, that the STA MLD is to access the premium wireless link and that the STA MLD did associate on the premium wireless link for the initial wireless association, transmitting a traffic identifier-to-link mapping (TTLM) to the STA MLD to enable the STA MLD to access the premium wireless link.

15. The media of claim 14, wherein the instructions, when executed by the processor, cause the processor to perform further operations, comprising:
upon determining that the STA MLD is to access the premium wireless link, that the STA MLD did not associate on the premium wireless link for the initial wireless association, and that the STA MLD is not capable of adding or deleting wireless links without performing a wireless reassociation with the AP MLD, transmitting a BTM request frame to the STA MLD to cause the STA MLD to perform a reassociation with the AP MLD to associate to a link set that includes the premium wireless link.

16. The media of claim 14, wherein determining, based on one or more criteria, whether the STA MLD is to access the premium wireless link includes one or more of:
determining that a Stream Classification Service (SCS) stream that is to utilize the premium wireless link is setup for the STA MLD;
determining that the STA MLD is communicating data traffic that is to utilize the premium wireless link;
determining, based on a service level agreement (SLA) for the STA MLD, that the STA MLD is to access the premium wireless link; or
determining, based on a policy associated with the STA MLD or a user associated with the STA MLD, that the STA MLD is to access the premium wireless link.

17. An apparatus comprising:
at least one memory element for storing data; and
at least one processor for executing instructions associated with the data, wherein executing the instructions causes the apparatus to perform operations, comprising:
for an initial wireless association between a station multi-link device (STA MLD) and an access point multi-link device (AP MLD), determining whether the STA MLD did or did not associate on a premium wireless link for the initial wireless association;
following the initial wireless association, determining, based on one or more criteria, whether the STA MLD is to access the premium wireless link provided by the AP MLD;
upon determining that the STA MLD is to access the premium wireless link, based on at least one of the one or more criteria being met, and that the STA MLD did not associate on the premium wireless link for the initial wireless association, determining whether the STA MLD is capable of adding or deleting wireless links without performing a wireless reassociation with the AP MLD;
upon determining that the STA MLD is to access the premium wireless link, that the STA MLD did not associate on the premium wireless link for the initial wireless association, and that the STA MLD is capable of adding or deleting wireless links without performing a wireless reassociation with the AP MLD, transmitting a Basic Service Set (BSS) Transmission Management (BTM) request frame or a link reconfiguration notify frame to the STA MLD to recommend to the STA MLD to add the premium wireless link to its multi-link (ML) setup without performing a reassociation with the AP MLD; and
upon determining, based on at least one of the one or more criteria being met, that the STA MLD is to access the premium wireless link and that the STA MLD did associate on the premium wireless link for the initial wireless association, transmitting a traffic identifier-to-link mapping (TTLM) to the STA MLD to enable the STA MLD to access the premium wireless link.

18. The apparatus of claim 17, wherein executing the instructions causes the apparatus to perform operations, comprising:
upon determining that the STA MLD is to access the premium wireless link, that the STA MLD did not associate on the premium wireless link for the initial wireless association, and that the STA MLD is not capable of adding or deleting wireless links without performing a wireless reassociation with the AP MLD, transmitting a BTM request frame to the STA MLD to cause the STA MLD to perform a reassociation with the AP MLD to associate to a link set that includes the premium wireless link.

19. The apparatus of claim 17, wherein determining, based on one or more criteria, whether the STA MLD is to access the premium wireless link includes one or more of:
determining that a Stream Classification Service (SCS) stream that is to utilize the premium wireless link is setup for the STA MLD;
determining that the STA MLD is communicating data traffic that is to utilize the premium wireless link;
determining, based on a service level agreement (SLA) for the STA MLD, that the STA MLD is to access the premium wireless link; or
determining, based on a policy associated with the STA MLD or a user associated with the STA MLD, that the STA MLD is to access the premium wireless link.

20. The apparatus of claim 17, wherein executing the instructions causes the apparatus to perform operations, comprising:
sending a link recommendation frame to the STA MLD to recommend the premium wireless link is to be used for certain traffic that is to be communicated by the STA MLD.
